(19) United States
(12) Patent Application Publication
(10) Pub. No.: US 2014/0292111 A1
(43) Pub. Date: Oct. 2, 2014

(54) STAGE DEVICE AND ELECTRON BEAM APPLICATION APPARATUS

(71) Applicant: EBARA CORPORATION, Tokyo (JP)

(72) Inventor: Matsutaro Miyamoto, Tokyo (JP)

(73) Assignee: EBARA CORPORATION, Tokyo (JP)

(21) Appl. No.: 14/228,839

(22) Filed: Mar. 28, 2014

(30) Foreign Application Priority Data
Mar. 28, 2013 (JP) 2013-069942
Mar. 28, 2013 (JP) 2013-069943

(51) Int. Cl. H02K 41/02

(52) U.S. Cl. CPC H02K 41/02
USPC 310/12.06

(57) ABSTRACT

A stage device of an electron beam application apparatus configured to irradiate a sample with an electron beam is configured in a compact and simple manner using a linear motor so that it is possible to minimize an influence of magnetic force of the linear motor to the process of inspection or processing of the sample. The stage device housed in a container is configured so that a first stage and a second stage disposed in upper and lower stages are driven by linear motors, respectively, and motor stationary elements and motor movable elements of both motors are disposed on the outside of an electron beam irradiation region so as not to enter this region during the process.

### CROSS REFERENCE TO RELATED APPLICATION

This application claims priority to Japanese Patent Applications No. 2013-69942 and 2013-69943 both filed on Mar. 28, 2013, the entire contents of which are hereby incorporated by reference.

### BACKGROUND OF THE INVENTION

The present invention relates to a structure of a stage device that is equipped in an electron beam application apparatus such as an electron beam inspection device or an electron beam lithography device configured to irradiate a sample held in a vacuum with charged particle beam (hereinafter, generally referred to as electron beam) of electron beam or ion beam.

Conventionally, in an electron beam application apparatus using an electron beam, such as a scanning electron microscope, in order to minimize an magnetic influence on the electron beam, a container itself, in which a stage device configured to hold and move a sample such as a wafer or a mask is incorporated, is formed of a magnetic material, or a magnetic material for magnetic shielding is integrally provided in the exterior or the interior of the container when the container is made of a non-magnetic material, thereby providing magnetic shielding (shield) so that the magnetic influence of the exterior of the container does not extend to the interior of the container.

Furthermore, the stage device itself is provided with means for minimizing the magnetic influence on the electron beam, similarly to the container, by forming the stage device basically by non-magnetic materials such as ceramics, an aluminum alloy, and a titanium alloy so that generation or variation of magnetism may not occur in the container.

As a drive type of the conventional stage device, a ball screw type which converts a rotary motion of a motor or the like into a linear motion has been widely used. In this type, for example, as illustrated in FIGS. 21 and 22, a stage device is configured so that guide rails 102, 102 are installed on a stage base plate 101 of a container 100, a first stage 104 connected to a ball screw shaft 103 is installed on the guide rails 102, 102, guide rails 105, 105 are installed on the first stage 104 in a direction that is orthogonal to the guide rails 102, 102, a second stage 107 connected to a ball screw shaft 106 via a guide is installed on the guide rails 105, 105, and by driving motors 108, 109 installed on the outside of the container 100 to rotate the ball screw shafts 103, 106, respectively, the first stage 104 is slidably moved along the guide rails 102, 102 and the second stage 107 is slidably moved along the guide rails 105, 105, thereby displacing a sample holding stage 111 installed on the second stage 107 to a predetermined position. In FIGS. 21 and 22, a stage mirror 110 is attached along upper surfaces of both sides with a corner of the sample holding stage 111 interposed therebetween.

With miniaturization of a sample such as a wafer, which is a target of inspection or processing, a stage device has required functions of high accuracy and high performance that are capable of accurately displacing the sample in a predetermined direction by a minute distance or stably displacing the sample at a predetermined distance without irregularity of speed. In the stage device of the ball screw type as illustrated above, there is a problem that during inspection or processing using the electron beam, high-frequency vibration generated from a plurality of ball bearings associated with the motion conversion through the ball screw shaft is mixed with the processing signal as noise or disturbance, thereby significantly reducing motion performance of the stage device.

As another drive type of the stage device, there is a type in which an air servo or an ultrasonic motor is used in driving means of the stage. However, in the former, as a container in which the stage device is housed increases in size, there is a need to increase the processing accuracy of components to keep a vacuum in the container, and the material costs tend to increase. The latter has drawbacks of an occurrence of dust, time degradation associated with the use, maintainability or the like.

Meanwhile, it is also useful to consider the use of a linear motor of a so-called linear motion type requiring no transmission elements of force, such as the ball screw shaft, as the driving means of the stage, in terms of simplicity of the configuration and superiority of the motor performance, and a stage device of an electron beam application apparatus having a linear motor configured as driving means of the stage has also been put to practical use (for example, see Patent Literatures 1 and 2).
[Patent Reference 1] Patent Literature 1: JP 2003-123680 A
[Patent Reference 2] Patent Literature 2: JP 2011-65956 A

### BRIEF SUMMARY OF THE INVENTION

When a stage device of an electron beam application apparatus is configured using a linear motor, since the linear motor drives an object by electromagnetic force, it is necessary to consider the device so that an influence of magnetic force due to the linear motor is minimized.

As described in Patent Literature 1, in a configuration in which a linear motor serving as a driving source is disposed on the outside of a container, the influence of magnetic force of the linear motor hardly extends to the interior of the container, but it is difficult to miniaturize a device including the container, and mechanical characteristics of the stage decrease due to complication of a structure of a transmission element of force or the like, thereby inhibiting and lowering the original performance of the stage device incorporating the linear motor.

Meanwhile, in a case of installing a stage device in which a linear motor is incorporated into a magnetically shielded container, there are following problems.

That is, as a stage which holds and moves a sample, a stage displaceable in orthogonal biaxial direction defined by an X-axis and a Y-axis is usually used, but a two-axis stage configuration of upper and lower stages is generally used in which an upper axis stage is disposed on a lower axis stage to overlap so that an occupation area is small and a compact configuration is obtained. When driving the two-axis stage by the linear motor, the linear motor configured to drive the upper axis stage is installed below the lower axis stage together with the upper axis stage, and the upper axis stage is also displaced by driving of the lower axis stage.

The upper axis stage is a stage that holds the sample via a sample holding stage disposed on the upper surface thereof, and is disposed close to a region in which the inspection or the processing of the sample is performed by the irradiation of the electron beam. Accordingly, due to displacement of the lower axis stage and the upper axis stage, the magnetic force of the linear motor has strong influence (regarding strength of the magnetic field and varying magnetic field) directly on the electron beam irradiation region, the stage is affected by the magnetic force of the linear motor configured to drive the upper axis stage disposed on the lower axis stage, and thus, the magnetic field variation of the electron beam irradiation region increases.

In a case of installing a stage device having a linear motor incorporated into a container, as disclosed in Patent Literature 2, when, between a pair of linear motors disposed so that a movable element is movable in the same direction, a pair of linear motors is disposed so that a movable element is movable in a direction intersecting with the same, and facing side portions of a lower axis stage and an upper axis stage disposed so as to vertically intersect are each connected to the movable element of the linear motor disposed at a corresponding position, thereby forming the stage device, since the linear motor configured to drive the upper axis stage is not close to the region in which the electron beam is irradiated, the influence of the magnetic force caused by the linear motor is reduced.

However, this configuration has a complicated structure, and it is also necessary to increase a size of the container that houses the stage device. Assembling is not easy because of the complicated structure, and it also takes time to perform adjustment for achieving an assembling accuracy of the components, which makes it difficult to form the electron beam application apparatus at low cost.

Furthermore, the interior of the magnetically shielded container of the electron beam application apparatus is held in a vacuum state so as to secure an incident trajectory of the electron beam, but when the linear motor is incorporated into the stage device, since the circumference is in a vacuum, heat generation of an exciting coil portion of the motor becomes a heat insulating state to raise the temperature of the motor itself, thereby reducing the performance and functions thereof, and the surrounding structures are also heated by heat transfer and radiant heat in association with the temperature rise of the motor, thereby adversely affecting the inspection and the processing of the sample.

In view of such problems of the related art, an object of the invention is to provide a stage device of an electron beam application apparatus configured to irradiate a sample with an electron beam in a simple and compact manner using a linear motor so as to be able to minimize an influence of magnetic force of the linear motor with respect to process of inspection or processing of the sample, thereby contributing to cost reduction of the electron beam application apparatus.

As described above, a stage device in which a linear motor configured to drive an upper axis stage is installed on a lower axis stage to form upper and lower two-axis stages has a small occupation area and is compact, a configuration thereof is simple, and an assembly thereof is also simple. In the stage device of this configuration, in the process of performing the inspection or the processing of the sample, as long as it is possible to effectively exclude the influence of the magnetic force of the linear motor displaced together with the upper axis stage, the accuracy of the inspection or the processing is not lowered, and there is no problem in practical use.

Accordingly, a first stage device of the invention is configured so that the influence of the magnetic force of the linear motor extending to an irradiation region of the electron beam is minimized as much as possible by adopting a form of installing the upper axis stage and the linear motor on the lower axis stage.

That is, in order to solve the above-described problems, according to one embodiment of the invention, there is provided a stage device installed in a magnetic shielding container that has an opening, to which an electron column is integrally attached, on an upper surface, the stage device including: a first linear motor that drives and displaces a first stage provided on a guide rail installed on a stage base plate along the guide rail; and a second linear motor that is installed on the first stage, and drives and displaces a second stage provided on a guide rail installed in a direction orthogonal to a displacement direction of the first stage above the first stage along the guide rail, wherein the stage device has a configuration in which motor stationary elements of the first and second linear motors are constituted by a permanent magnet, and the motor stationary elements and motor movable elements of both motors are disposed on the outside of an projection region onto the stage base plate of the opening of the container.

According to this configuration, by disposing the linear motor configured to drive each of the upper and lower stages on the outside of the projection region onto the stage base plate of the opening of the container so as not to enter an electron beam irradiation region serving as the projection region, the electron beam irradiation region is hardly affected by the magnetic force caused by the linear motor, and it is possible to ensure the accuracy of the correct inspection or processing of the sample.

Furthermore, when the entire container in which the stage device is housed is formed of a magnetic material or a non-magnetic material, by integrally providing a magnetic material for magnetic shielding on the inside or the outside of the container to provide a magnetic shielding structure, and by forming a circumference of the opening of the upper surface to which the electron column is attached by a magnetic material, lines of magnetic force in the container enter a state of flowing through a circumferential surface of the container as a magnetic material side, the lines of magnetic force are hard to flow in the opening, particularly, in a central portion thereof, and the opening may be hardly affected by the magnetic force due to the linear motor.

In addition, as described above, in the stage device in which the linear motor configured to drive the upper axis stage is installed on the lower axis stage to form the upper and lower two-axis stages, when installing the linear motor on the upper axis stage, the irradiation region of the electron beam is easily affected by the magnetic force of the linear motor.

Therefore, the second stage device of the invention was configured so that the irradiation region of the electron beam is hardly affected by the magnetic force of the linear motor as much as possible, by installing the linear motor such that the motor stationary element of the linear motor is immobile at a position away from the irradiation region of the electron beam and during movement of the lower axis stage, and so that the configuration is simple and compact, and the assembly and adjustment become simple.

That is, in order to solve the above-described problems, according to another embodiment of the invention, there is provided a stage device installed in a magnetic shielding container that has an opening, to which an electron column is integrally attached, on an upper surface, the stage device including: a first linear motor that drives and displaces a first stage provided on a guide rail installed on a stage base plate along the guide rail; and a second linear motor that drives and displaces a second stage provided on a guide rail installed in a direction orthogonal to a displacement direction of the first stage above the first stage along the guide rail, wherein the first and second linear motors are configured so that a motor stationary element constituted by a permanent magnet is installed on the stage base plate, the first stage and a motor movable element of the first linear motor are integrally connected to each other, and the second stage and a motor movable element of the second linear motor have a configuration in which a stage connection guide connected to the motor movable element is freely slidably attached and connected to a linear guide rail provided along at least one side end portion of the second stage.

In the stage configured in the general orthogonal two axes, the upper axis stage (second stage) is installed on a movable side of the lower axis stage (first stage). Here, if a linear motor is used as a driving source of the upper axis stage, a side on which a magnet serving as a magnetic generation source of the linear motor is provided is disposed at a position away from the electron beam irradiation region, and is configured to be immovable during movement of the lower axis stage, the electron beam irradiation region is hardly affected by the magnetic force caused by the linear motor, and it is possible to ensure the accuracy of the correct inspection or processing of the samples.

Furthermore, as in the above-described configuration, if a linear motor is also used as a driving source of the lower axis stage, and a motor stationary element side is disposed as a permanent magnet at a position away from the electron beam irradiation region in the same manner as described above, the effect caused by the magnetic force of the linear motor becomes smaller, the magnetic variation is eliminated, and benefits of the stage drive using the linear motor are achieved in both axes.

Furthermore, as in the first stage device, when the entire container, in which the stage device is housed, is made of a magnetic material or a non-magnetic material, a magnetic material for magnetic shielding is integrally provided on the outside or the inside of the container to provide a magnetic shielding structure, and the circumference of the opening of the upper surface to which the electron column is attached is formed of a magnetic material, and thus, lines of magnetic force in the container are in a state of flowing through a circumferential surface of the container as a magnetic material side. Accordingly, the lines of magnetic force are hard to flow in the opening, particularly, in a central portion thereof, and the central portion can be hardly affected by magnetic force caused by the linear motor.

In the stage device of the above-described configuration, the motor stationary elements of a pair of linear motors configured to drive and displace each of the first stage and/or the second stage may be configured to be disposed on the stage base plate of both sides of the stage.

According to this configuration, by connecting and driving the linear motor to both sides of the stage, the position accuracy during stage movement is improved, driving power required for each motor decreases to reduce the size of the motor, symmetry of the magnetic distribution of the linear motor with respect to the electron beam irradiation region is achieved, and thus, the influence of magnetic force can be reduced. Even when the linear motors are disposed on both sides of only one of the first stage and the second stage, the same effect can be expected.

Furthermore, in the stage device of the above-described configuration, the motor stationary elements of the linear motor configured to drive and displace the first stage may be disposed along one opposite two sides on the stage base plate, and the motor stationary elements of the linear motor configured to drive and displace the second stage may be disposed along the other opposite two sides, the motor stationary elements may be installed so that polarities of magnets of the end portions of the motor stationary elements adjacent to each other with a corner portion of the stage base plate interposed therebetween are different from each other.

Thus, with the configuration in which the magnetic poles of the magnets of the end portions of the motor stationary elements of the linear motor adjacent to each other are different from each other, magnetic field is formed between the end portions of the adjacent motor stationary elements, there is no leakage magnetic field, and it is possible to reduce the influence of the magnetic field to the circumference of the stage device.

Furthermore, in the stage device of the above-described configuration, the motor stationary elements of the linear motor may be disposed so as to be close to or contact with an inner surface of a container made of a magnetic material or so as to overlap the inner surface of the container via a member made of a magnetic material contacting with the motor stationary elements, rather than being installed on the stage base plate.

Thus, the lines of magnetic force caused by the magnets of the motor stationary elements of the linear motor flow through the container made of a magnetic material, and thus, it is possible to further reduce the magnetic influence in the container and the influence of the magnetic field to the electron beam irradiation region in the opening.

Furthermore, in the stage device of the above-described configuration, the linear motor is preferably disposed on the outside of the projection region onto the stage base plate of the opening of the container.

According to this configuration, since the linear motor configured to drive each of the upper and lower stages is disposed on the outside of the projection region onto the stage base plate of the opening of the container so as not to enter the electron beam irradiation region serving as the projection region, the electron beam irradiation region is hardly affected by the magnetic force caused by the linear motor, and it is possible to secure the accuracy of the inspection and the processing of the sample.

In the configuration of the first stage device and the second stage device, it is preferable to have a configuration in which a cooling unit is integrally attached to the surface of the motor movable element of the linear motor.

According to this configuration, the temperature rise of the linear motor is effectively suppressed to prevent the decreases of its performance and function, the surrounding structure is not heated by heat transfer or radiant heat due to heat generation of the motor, and it is possible to prevent the decrease of accuracy of the inspection and the processing of the sample due to the heat generation of the linear motor.

As the cooling unit, for example, it is possible to configure the cooling unit so that, for example, a cooling jacket is integrally attached to the surface of the motor moving element, a cooling pipe block filled with appropriate refrigerant is installed on the motor stationary element side, the cooling jacket and the cooling pipe block are connected by a pair of flexible pipes, and thus, the refrigerant flows between the cooling piping block and the cooling jacket.

Furthermore, the electron beam application apparatus of the invention may have a container that houses the stage device having the above-described configuration.

That is, it is possible to configure an electron beam application apparatus, by housing the stage device of the above-described configuration in the magnetically shielded container, providing an exhaust unit such as a vacuum pump configured to make the interior of the container a vacuum state, and integrally attaching the electron column to the opening of the container that is hardly magnetically affected.

According to this configuration, by combining the high-accuracy stage having excellent dynamic performance with the electron column that is hardly magnetically affected, it is possible to configure a high-performance electron beam application apparatus having a simple configuration at low cost.

In the electron beam application apparatus having the above-described configuration, it is preferable to provide a configuration in which a movement direction of the first stage of the stage device is set to a step axis, and a movement direction of the second stage is set to a scan axis.

That is, in the stage that is displaceable in an orthogonal two-axis direction, in the case of the upper and lower stages in which the upper axis stage is installed on the lower axis stage to overlap, since a movable mass of the upper axis stage inevitably decreases, ability and accuracy to continuously run (scan ability and accuracy) are superior to those of the lower axis stage. Meanwhile, ability and accuracy to move by a short distance and stop (step ability and accuracy) are not significantly inhibited even when the movable mass increases. Therefore, if the movement direction of the first stage (lower axis stage) is set to a step axis, and the movement direction of the second stage (upper axis stage) is set to the scan axis, a stage of a so-called scan type, in which the scan and the step are repeated, is ideally formed.

In addition, the stage device in the electron beam inspection device having the above-described configuration is preferably configured so that during at least inspection and/or processing of the sample using the electron beam, the motor stationary element and the motor movable element of the second linear motor do not enter the projection region onto the stage base plate of the opening of the container.

That is, in the process of performing the inspection or the processing of the sample, by operating the stage device so as not to enter the electron beam irradiation region serving as a projection region of the opening of the container, the influence of magnetic force caused by the linear motor during process is minimized, and it is possible to secure the accuracy of the correct inspection or processing of the sample.

Furthermore, if a flange portion protruding downward is provided in the peripheral edge of the opening of the container to which the electron column is attached, lines of magnetic force are hard to flow in the opening of the container, and thus, it is possible to further reduce the influence of the magnetic force of the linear motor.

### BRIEF DESCRIPTION OF THE SEVERAL VIEWS OF THE DRAWINGS

FIG. 1 is a schematic plan view illustrating a configuration of one embodiment of a first stage device of the invention;

FIG. 2A is a side view of an arrow A side of FIG. 1, and FIG. 2B is a side view of an arrow B side of FIG. 1;

FIG. 3 is a schematic external view of a container in which a stage device is housed;

FIG. 4 is an enlarged cross-sectional view of an opening of the container;

FIG. 5 is a schematic plan view of a state in which the stage device of FIG. 1 is housed in the container of FIG. 3;

FIG. 6A is a transmission side view of an arrow A side of FIG. 5, and FIG. 6B is a transmission side view of an arrow B side of FIG. 5;

FIG. 7 is a schematic plan view illustrating a configuration of another embodiment of the first stage device;

FIG. 8A is a side view of an arrow A side of FIG. 7 and FIG. 8B is a side view of an arrow B side of FIG. 7;

FIG. 9 is a schematic plan view illustrating a configuration of an embodiment of a second stage device of the invention;

FIG. 10A is a side view of an arrow A side of FIG. 9, and FIG. 10B is a side view of an arrow B side of FIG. 9;

FIG. 11 is a schematic plan view of a state in which the stage device of FIG. 9 is housed in the container of FIG. 3;

FIG. 12A is a transmission side view of an arrow A side of FIG. 11, and FIG. 12B is a transmission side view of an arrow B side of FIG. 11;

FIG. 13 is a schematic plan view illustrating a configuration of another embodiment of the second stage device;

FIG. 14A is a transmission side view of an arrow A side of FIG. 13, and FIG. 14B is a transmission side view of an arrow B side of FIG. 13;

FIG. 15 is a schematic plan view illustrating a configuration of still another embodiment of the second stage device;

FIG. 16A is a transmission side view of an arrow A side of FIG. 15, and FIG. 16B is a transmission side view of an arrow B side of FIG. 15;

FIG. 17 is a schematic plan view illustrating a configuration of still another embodiment of the second stage device;

FIG. 18A is a transmission side view of an arrow A side of FIG. 17, and FIG. 18B is a transmission side view of an arrow B side of FIG. 17;

FIG. 19 is a diagram illustrating a configuration of a cooling unit attached to a linear motor;

FIG. 20 is a cross-sectional view taken from a line A-A of FIG. 19;

FIG. 21 is a schematic plan view illustrating a configuration of a stage device of a conventional ball screw type; and

FIG. 22A is a transmission side view of an arrow A side of FIG. 21, and FIG. 22B is a transmission side view of an arrow B side of FIG. 21.

### DETAILED DESCRIPTION OF THE INVENTION

Preferred embodiments of the invention will be described with reference to the accompanying drawings.

First, a first stage device of the invention and an electron beam application apparatus equipped with the same will be described.

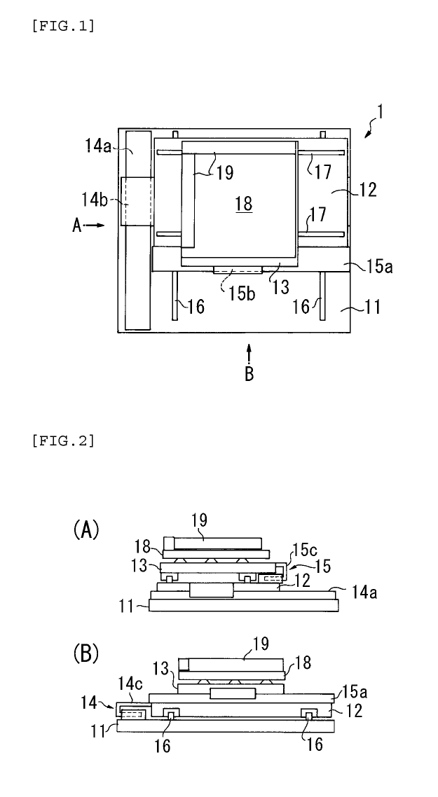

FIGS. 1 and 2 illustrate an exemplary embodiment of the first stage device of the invention, a stage device 1 is configured so that a step axis stage (first stage) 12 and a scan axis stage (second stage) 13 are disposed on a stage base plate 11 so as to overlap in upper and lower stages, and the step axis stage 12 and the scan axis stage 13 linearly move in a direction orthogonal to each other by a linear motor 14 of the step axis and a linear motor 15 of the scan axis, respectively. The linear motors 14 and 15 are constituted by a motor stationary element as a permanent magnet and a motor movable element as an electromagnetic coil.

More specifically, the stage base plate 11 has a substantially square shape in a plan view, a pair of guide rails 16, 16 is installed on an upper surface thereof at an appropriate interval, and a motor stationary element 14a of the linear motor 14 is disposed on one side thereof to be parallel to the guide rails 16, 16.

The step axis stage 12 has a rectangular shape in a plan view and is attached so as to be slidably displaced on both rails by engaging a bottom portion thereof with the guide rails 16, 16, the motor movable element 14b of the linear motor 14 is integrally connected to a side portion thereof via a movable element connection portion 14c, and thus, the step axis stage 12 is installed so as to run along the guide rails 16, 16 by driving the linear motor 14.

A pair of guide rails 17, 17 is installed on the upper surface of the step axis stage 12 at an appropriate interval in a direction orthogonal to the guide rails 16, 16, that is, in a direction orthogonal to a running direction of the step axis stage 12, and on a side of a side portion adjacent to a side portion to which the motor movable element 14b is connected with a corner portion interposed therebetween, a motor stationary element 15a of the linear motor 15 is disposed parallel to the guide rails 17, 17.

The scan axis stage 13 has a square shape in a plan view and is attached so as to be slidably displaceable on both rails by engaging a bottom portion thereof with the guide rails 17, 17, a motor movable element 15b of the linear motor 15 is integrally connected to a side portion thereof via a movable element connection portion 15c, and thus, the scan axis stage 13 is installed so as to run on the step axis stage 12 along the guide rails 17, 17 by driving the linear motor 15.

A sample holding stage 18 configured to hold a sample is installed on the scan axis stage 13, stage mirrors 19, 19 serving as measurement targets (targets) of a length measurement meter used for a position control of the stage are mounted on the upper surface of the sample holding stage 18 and are installed so as to allow the length measurement of an orthogonal two-axis direction serving as a movement axis of the stage.

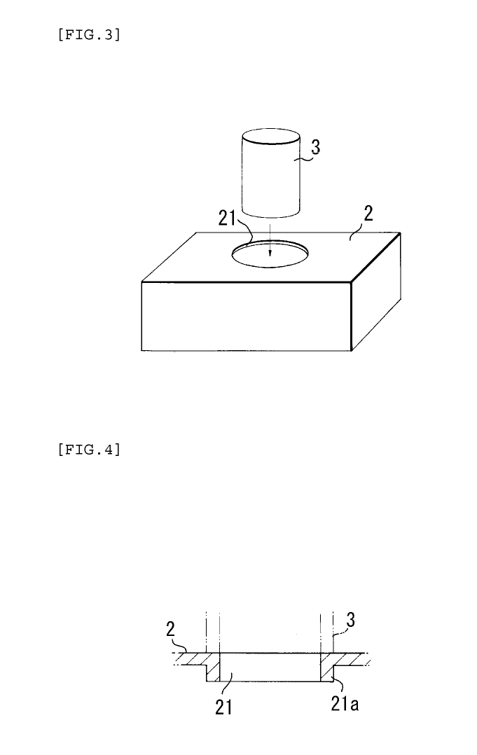

As illustrated in FIG. 3, the stage device 1 configured as described above is housed in the container 2 of a box body having a substantially cubic shape made of a magnetic material. An opening 21 having the electron column 3 integrally attached thereto is formed on the upper surface of the container 2, and in a peripheral edge of the opening 21, as illustrated in FIG. 4, a flange portion 21a projecting downward is formed.

Moreover, the stage device 1 is installed in the container 2, the electronic column 3 is integrally attached to the opening 21, an exhaust unit such as a vacuum pump configured to make the interior of the container 2 a vacuum state, a unit configured to irradiate the sample with an electron beam, a unit configured to convey the sample to the stage and the like are equipped, thereby forming an electron beam application apparatus.

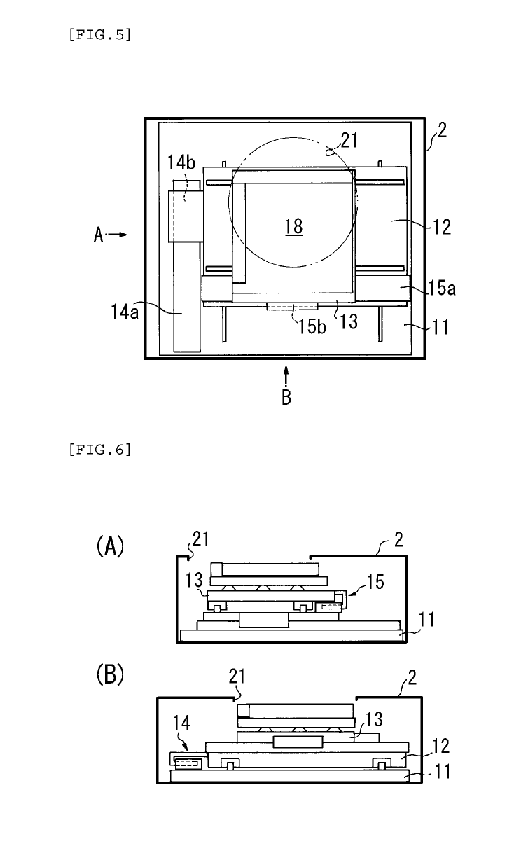

As illustrated in FIGS. 5 and 6, the stage device 1 in the container 2 is provided so that the motor stationary elements 14a and 15a and the motor movable elements 14b and 15b of the linear motors 14 and 15 are disposed on the outside of a projection region onto the stage base plate 11 of the opening 21 so as not to enter the projection region of the container 2 even during process of performing the inspection and the processing of the sample. Accordingly, the electron beam irradiation region is hardly affected by the magnetic force caused by the linear motor, and it is possible to secure the accuracy of the correct inspection or processing of the sample.

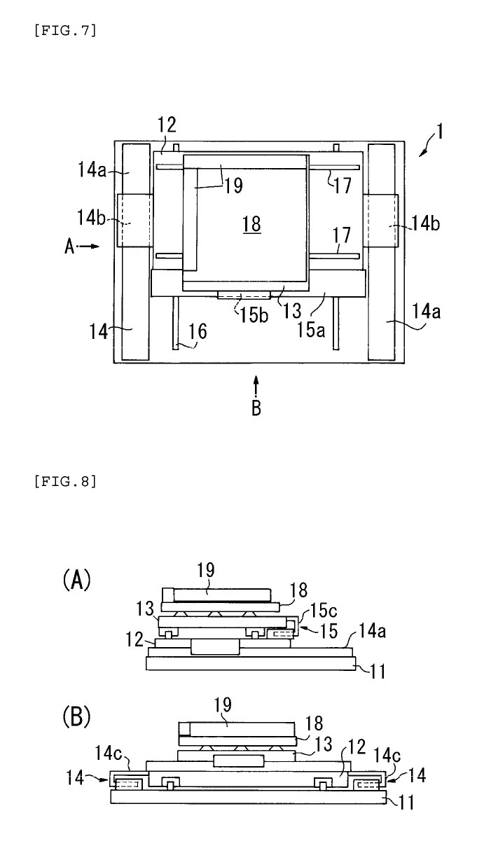

FIGS. 7 and 8 illustrate another embodiment of the stage device 1. This is configured so that the motor stationary elements 14a, 14a of the linear motor 14, 14 are disposed parallel to the guide rails 16, 16 along both sides of the upper surface of the stage base plate 11, and motor movable elements 14b, 14b are integrally connected to both side portions of the step axis stage 12 via a movable element connection portion 14c.

By driving the linear motors 14, 14 while being connected to both sides of the step axis stage 12, a position accuracy during stage movement is improved, drive power required for each motor decreases to achieve miniaturization of the motor, symmetry of the magnetic distribution of the linear motor with respect to the electron beam irradiation region is achieved, and thus, it is possible to reduce the influence of magnetic force. The linear motors 15 may also be driven by being disposed on both sides of the scan axis stage 13. In these cases, similarly to the above-described case, the stage device 1 is installed in the container 2 so that the motor stationary elements 14a and 15a and the motor movable elements 14b and 15b of each of the linear motors 14 and 15 are disposed on the outside of the projection region onto the stage base plate 11 of the opening 21.

Next, a second stage device of the invention and an electron beam application apparatus equipped with the same will be described.

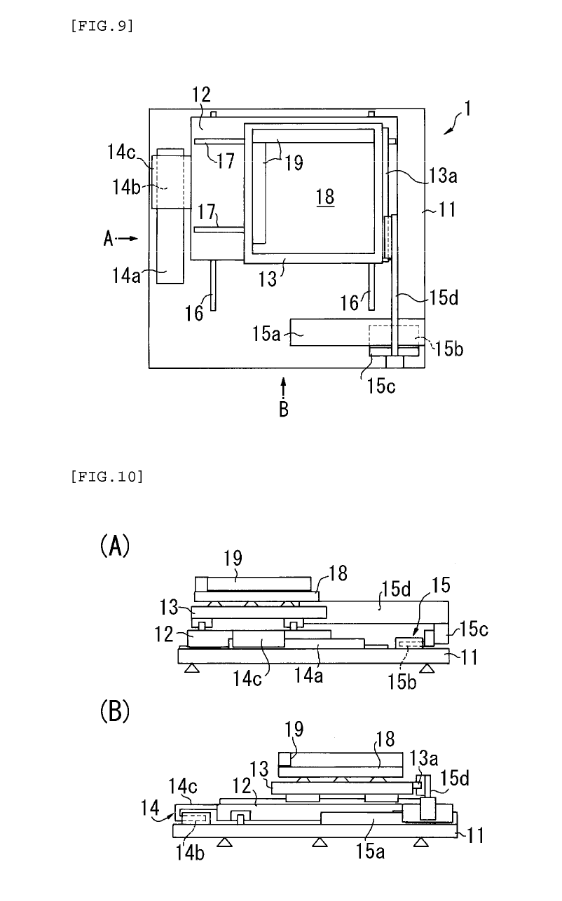

FIGS. 9 and 10 illustrate an embodiment of a second stage device of the invention, the stage device 1 is configured so that the step axis stage (first stage) 12 and the scan axis stage (second stage) 13 are disposed on the stage base plate 11 so as to overlap in upper and lower stages and are linearly moved in the direction orthogonal to each other by the linear motor 14 of the step axis and the linear motor 15 of the scan axis, respectively. The linear motors 14 and 15 are configured by the motor stationary element as a permanent magnet and the motor movable element as an electromagnetic coil.

Specifically, the stage base plate 11 has a substantially square shape in a plan view, a pair of guide rails 16, 16 is installed on an upper surface thereof at an appropriate interval, and the motor stationary element 14a of the linear motor 14 is disposed on one side thereof to be parallel to the guide rails 16, 16. Furthermore, on the other side adjacent to the one side with a corner portion interposed therebetween, the motor stationary element 15a of the linear motor 15 is disposed in a direction orthogonal to the guide rails 16, 16.

The step axis stage 12 has a rectangular shape in a plan view and is attached so as to be slidably displaceable on both rails by engaging a bottom portion thereof with the guide rails 16, 16, the motor movable element 14b of the linear motor 14 is integrally connected to a side portion thereof via a movable element connection portion 14c, and the step axis stage 12 is installed so as to run along the guide rails 16, 16 by driving the linear motor 14.

A pair of guide rails 17, 17 is installed on the upper surface of the step axis stage 12 at an appropriate interval in a direction orthogonal to the guide rails 16, 16, that is, in a direction orthogonal to a running direction of the step axis stage 12.

The scan axis stage 13 has a square shape in a plan view and is attached so as to be slidably displaceable on both rails by engaging a bottom portion thereof with the guide rails 17, 17, and the linear guide rail 13a is integrally attached to the side portion thereof.

Moreover, a stage connection guide 15d serving as a power transmission element, which is connected to the motor movable element 15b of the linear motor 15 via a movable element connection portion 15c and extends parallel to the running direction of the step axis stage 12, is slidably connected to the linear guide rail 13a. By driving the linear motor 15, the power thereof is transmitted to the scan axis stage 13 via the stage connection guide 15d, the scan axis stage 13 runs on the step axis stage 12 along the guide rails 17, 17, and when the step axis stage 12 is displaced, the stage connection guide 15d relatively slides along the linear guide rail 13a, thereby displacing the scan axis stage 13 integrally with the step axis stage 12.

A sample holding stage 18 configured to hold the sample is provided on the scan axis stage 13, stage mirrors 19, 19 serving as measurement targets (target) of a length measuring meter used for position control of the stage are mounted on the upper surface of the sample holding stage 18 to allow the length measurement in the orthogonal two-axis direction as a movement axis of the stage.

As illustrated in FIG. 3, the stage device 1 configured as described above is housed in the container 2 of the box body having an approximate cubic shape made of a magnetic material. An opening 21 to which the electron column 3 integrally attached is formed on the upper surface of the container 2, and as illustrated in FIG. 4, a flange portion 21a projecting downward is provided on the peripheral edge of the opening 21.

Moreover, the stage device 1 is installed in the container 2, the electron column 3 is integrally attached to the opening 21, and an exhaust unit such as a vacuum pump configured to make the interior of the container 2 a vacuum state, a unit configured to irradiate the sample with an electron beam, a unit configured to convey the sample to the stage and the like are equipped, thereby forming an electron beam application apparatus.

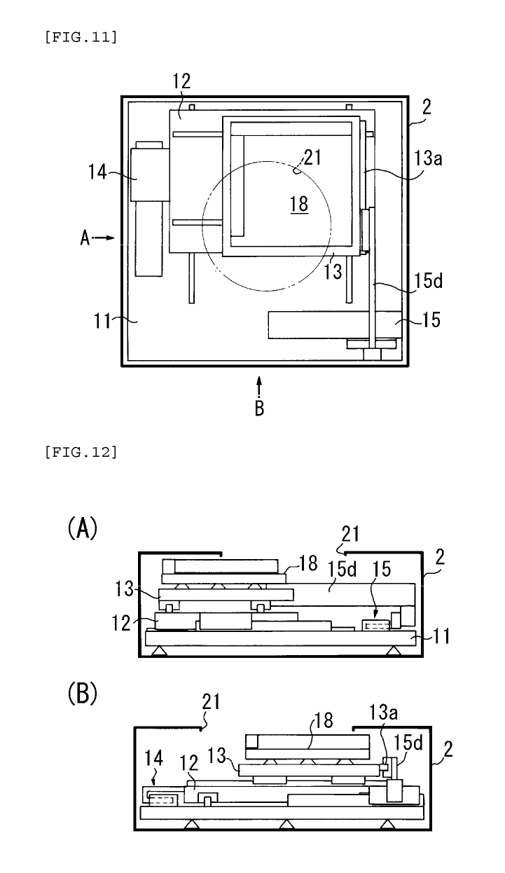

As illustrated in FIGS. 11 and 12, the stage device 1 in the container 2 is configured so that the linear motors 14 and 15 are disposed on the outside of the projection region onto the stage base plate 11 of the opening 21. Thus, the electron beam irradiation region is hardly affected by the magnetic force caused by the linear motor, and it is possible to secure the accuracy of the correct inspection or processing of the sample.

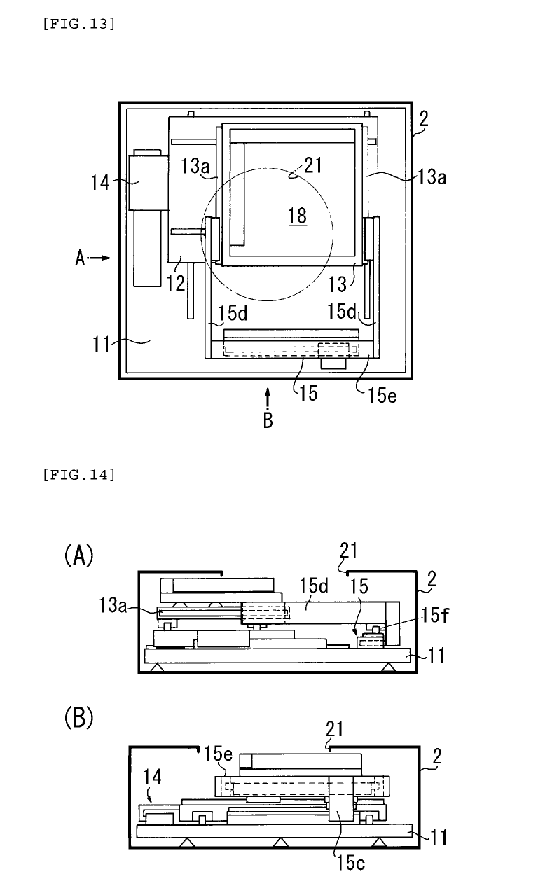

FIGS. 13 and 14 illustrate another embodiment of the stage device 1. The stage device is configured so that the linear guide rails 13a, 13a are integrally attached to both side portions of the scan axis stage 13, a movable element connection portion 15e guided by a linear guide 15f installed in the vicinity of the motor stationary element 15a is connected to a motor movable element 15b of the linear motor 15, stage connection guides 15d, 15d are attached to both ends of the movable element connection portion 15e, both stage connection guides 15d, 15d are slidably connected to the linear guide rails 13a, 13a, and both sides of the scan axis stage 13 are supported by the stage connection guides 15d, 15d.

According to this configuration, by connecting the stage connection guides 15d, 15d to both sides of the scan axis stage 13, it is possible to stably run the scan axis stage 13 rather than a cantilever type described above in which the stage connection guide 15d is connected to only one side portion of the scan axis stage 13.

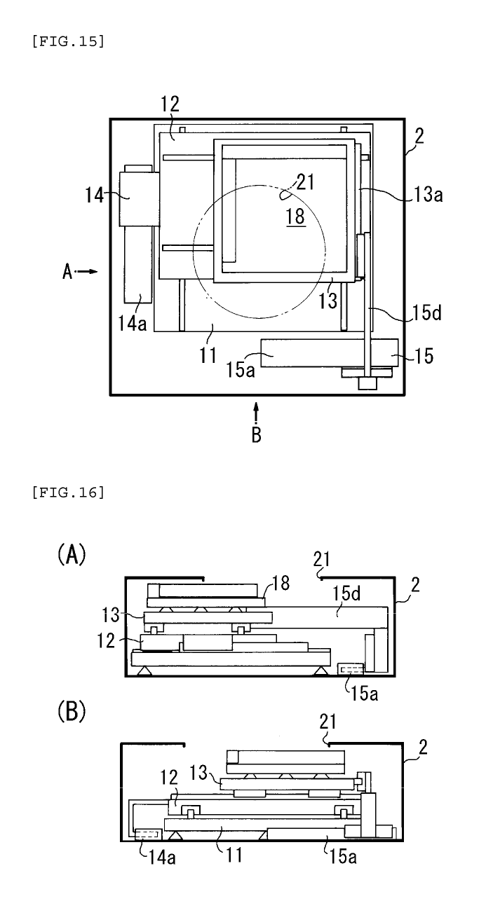

Furthermore, FIGS. 15 and 16 illustrate still another embodiment of the stage device 1. The device is configured so that the motor stationary elements 14a and 15a of the linear motors 14 and 15 are directly connected to the lower surface of the container 2 made of a magnetic material.

Thus, lines of magnetic force caused by the magnets of the motor stationary elements 14a and 15a of the linear motors 14 and 15 directly flow in the container 2, and thus, it is possible to reduce the magnetic influence within the container 2. Similar effects can be expected even when a member made of a magnetic material is interposed between the motor stationary elements 14a and 15a and the inner surface of the container 2.

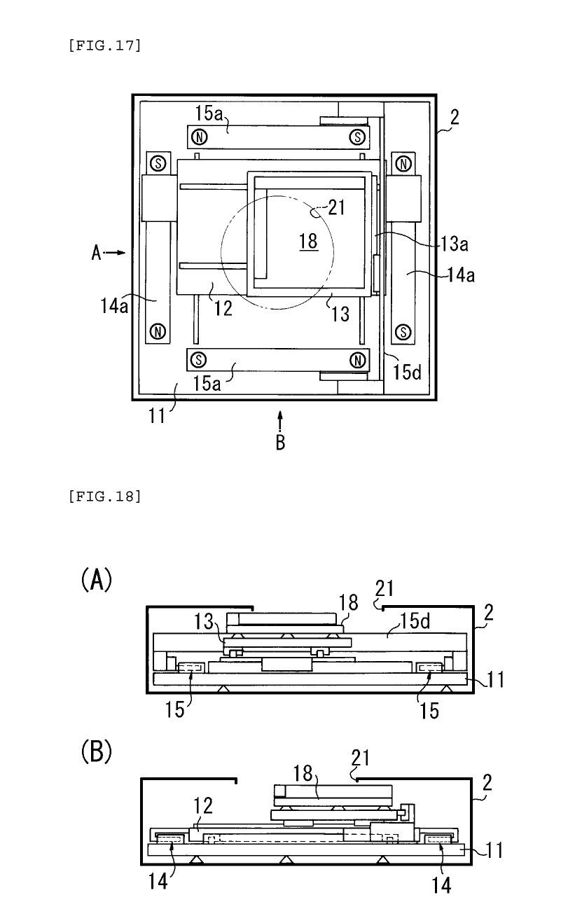

Furthermore, FIGS. 17 and 18 illustrate still another embodiment of the stage device 1. The stage device 1 is configured so that the motor stationary elements 14a, 14a of the linear motors 14, 14 are installed along one opposite two sides on the stage base plate 11, the motor stationary elements 15a, 15a of the linear motors 15, 15 are disposed along the other opposite two sides, respectively, the linear motors 14 and 15 are connected to both sides of the step axis stage 12 and the scan axis stage 13, and both stages are driven by a pair of linear motors 14 and 15.

Thus, the position accuracy during stage movement is improved, miniaturization of the motor is achieved, and symmetry of the magnetic distribution of the linear motor with respect to the electron beam irradiation region is achieved, and thus, it is possible to reduce the influence of magnetic force.

In this case, as illustrated in FIG. 17, as long as each of the motor stationary elements 14a and 15a is disposed so that polarities of the magnets of the end portions of the motor stationary elements 14a and 15a adjacent to each other with a corner of the stage base plate 11 interposed therebetween are different from each other, since magnetic field is formed between the end portions of the adjacent motor stationary elements 14a and 15a, there is no leakage magnetic field, and it is possible to reduce the influence of the magnetic field to the periphery of the stage device 1.

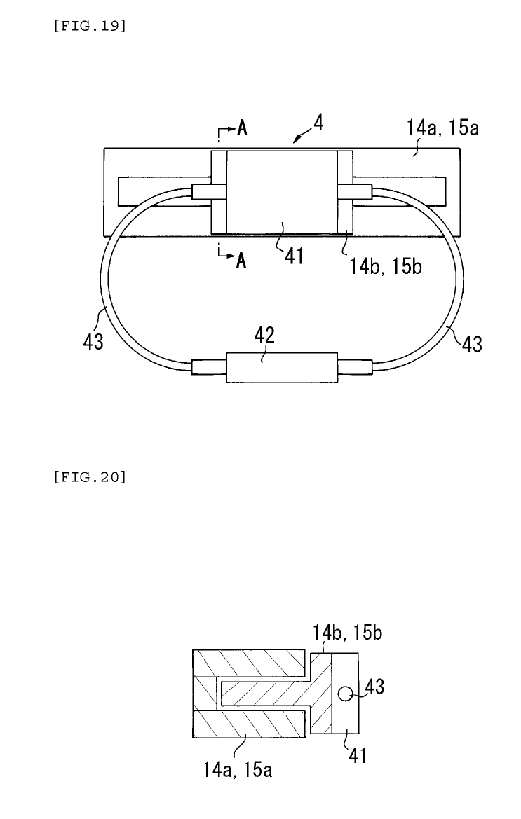

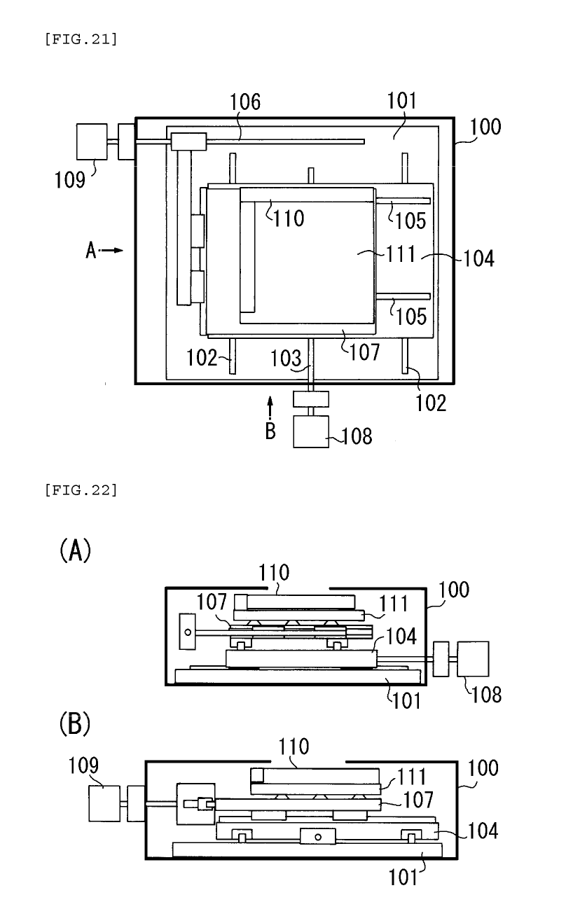

FIGS. 19 and 20 illustrate a cooling unit attached to the motor movable elements 14b and 15b of the linear motors 14 and 15 in the first and second stage device 1.

The cooling unit 4 includes a cooling jacket 41 integrally attached to the surfaces of the motor movable elements 14b and 15b, and a cooling pipe block 42 that is installed on the motor stationary elements 14a and 15a side and serves as an appropriate circulation concentration portion of the refrigerant. The cooling unit is configured so that the refrigerant circulates between the cooling pipe block 42 and the cooling jacket 41 by connecting the cooling jacket 41 and the cooling pipe block 42 using a pair of flexible pipes 43, 43, and thus the motor movable elements 14b and 15b are cooled. The flexible pipes 43, 43 are pipes that have a suitable length having flexibility, such as tubes, do not inhibit the movement of the stage, and are disposed such that reaction force is constant.

The cooling jacket 41 is formed of a material having excellent thermal conductivity. Furthermore, a pipe (not illustrated), which allows supply and discharge of the refrigerant from the outside of the container 2, is connected to the cooling pipe block 42.

In addition, the illustrated embodiment is an example, and the invention is not limited thereto and can be configured in other suitable forms. Constitution of a stage device or an electron beam application apparatus by combination of the illustrated embodiments is appropriately performed.
1: stage device
11: stage base plate
12: step axis stage (first stage)
13: scan axis stage (second stage)
13a: linear guide rail
14, 15: linear motor
14a, 15a: motor stationary element
14b, 15b motor movable element
14c, 15c, 15e: movable element connection portion
15d: stage connection guide
15f: linear guide
16, 17: guide rail
18: sample holding stage
19: stage mirror
2: container
21: opening
21a: flange portion
3: electronic column
4: cooling unit
41: cooling jacket
42: cooling pipe block
43: flexible pipe

What is claimed is:

1. A stage device installed in a magnetic shielding container having an opening on an upper surface of the container, wherein an electron column is integrally attached to the opening, the stage device comprising:
a first linear motor that drives and displaces a first stage provided on a first guide rail installed on a stage base plate along the first guide rail; and
a second linear motor that is installed on the first stage and drives and displaces a second stage provided on a second guide rail installed in a direction orthogonal to a displacement direction of the first stage above the first stage along the second guide rail,
wherein the first and second linear motors comprise motor stationary elements and motor movable elements, respectively, and each of the motor stationary elements is composed of a permanent magnet, and the motor stationary elements and the motor movable elements are disposed on an outside of an projection region of the opening onto the stage base plate.

2. A stage device installed in a magnetic shielding container having an opening on an upper surface of the container, wherein an electron column is integrally attached to the opening, the stage device comprising:
a first linear motor that drives and displaces a first stage provided on a first guide rail installed on a stage base plate along the first guide rail; and
a second linear motor that drives and displaces a second stage provided on a second guide rail installed in a direction orthogonal to a displacement direction of the first stage above the first stage along the second guide rail,
wherein the first and second linear motors comprise motor stationary elements and motor movable elements, respectively, and each of the motor stationary elements is composed of a permanent magnet and installed on the stage base plate,
the first stage and the motor movable element of the first linear motor are integrally connected to each other, and
the second stage and the motor movable element of the second linear motor are configured so that a stage connection guide connected to the motor movable element of the second linear motor is slidably attached and connected to a linear guide rail provided along a side end portion of at least one side of the second stage.

3. The stage device according to claim 1, wherein the motor stationary elements of the first and second linear motors that drive and displace each of the first stage and/or the second stage are disposed on the stage base plate of both sides of each of the first and second stages, respectively.

4. The stage device according to claim 1, wherein the first linear motor includes a pair of first linear motors and the second linear motor includes a pair of second linear motors, each of the pair of first linear motors drives and displaces the first stage and comprises a first motor stationary element, and each of the pair of second linear motors drives and displaces the second stage and comprises a second motor stationary element, wherein the first motor stationary elements are disposed along one of opposing two sides of the stage base plate and the second motor stationary elements are disposed along another of the opposing two sides of the stage base plate, and
wherein the first motor stationary elements and the second motor stationary elements are installed so that end portions of each of the first and second motor stationary elements adjacent to each other through each corner of the stage base plate have different magnetic polarities.

5. The stage device according to claim 1, wherein the magnetic shielding container is made of a magnetic material, and each of the motor stationary elements is disposed so as to be close to or contact with an inner surface of the container, or so as to be stacked on the inner surface of the container through a member made of a magnetic material contacting with each of the motor stationary elements.

6. The stage device according to claim 2, wherein each of the first and second linear motors is disposed on an outside of a projection region of the opening onto the stage base plate.

7. The stage device according to claim 1, further comprising a cooling unit integrally attached to a surface of each of the motor movable elements.

8. An electron beam application apparatus comprising a container that houses the stage device according to claim 1.

9. The electron beam application apparatus according to claim 8, wherein a movement direction of the first stage of the stage device is a step axis and a movement direction of the second stage of the stage device is a scan axis.

10. The electron beam application apparatus according to claim 8, wherein during at least inspection and/or processing of a sample using an electron beam, the motor stationary element and the motor movable element of the second linear motor do not enter the projection region of the opening onto the stage base plate.

11. The electron beam application apparatus according to claim 8, further comprising a flange portion protruding downward and provided on a peripheral edge of the opening to which the electron column is attached.

12. The stage device according to claim 2, wherein the motor stationary elements of the first and second linear motors that drive and displace each of the first stage and/or the second stage are disposed on the stage base plate of both sides of each of the first and second stages, respectively.

13. The stage device according to claim 2, wherein the first linear motor includes a pair of first linear motors and the second linear motor includes a pair of second linear motors, each of the pair of first linear motors drives and displaces the first stage and comprises a first motor stationary element, and each of the pair of second linear motors drives and displaces the second stage and comprises a second motor stationary element, wherein the first motor stationary elements are disposed along one of opposing two sides of the stage base plate and the second motor stationary elements are disposed along another of the opposing two sides of the stage base plate, and
wherein the first motor stationary elements and the second motor stationary elements are installed so that end portions of each of the first and second motor stationary elements adjacent to each other through each corner of the stage base plate have different magnetic polarities.

14. The stage device according to claim 2, wherein the magnetic shielding container is made of a magnetic material, and each of the motor stationary elements is disposed so as to be close to or contact with an inner surface of the container, or so as to be stacked on the inner surface of the container through a member made of a magnetic material contacting with each of the motor stationary elements.

15. The stage device according to claim 2, further comprising a cooling unit integrally attached to a surface of each of the motor movable elements.

16. An electron beam application apparatus comprising a container that houses the stage device according to claim 2.

17. The electron beam application apparatus according to claim 16, wherein a movement direction of the first stage of the stage device is a step axis and a movement direction of the second stage of the stage device is a scan axis.

18. The electron beam application apparatus according to claim 16, wherein during at least inspection and/or processing of a sample using an electron beam, the motor stationary element and the motor movable element of the second linear motor do not enter the projection region of the opening onto the stage base plate.

19. The electron beam application apparatus according to claim 16, further comprising a flange portion protruding downward and provided on a peripheral edge of the opening to which the electron column is attached.
